(19) United States
(12) Patent Application Publication
(10) Pub. No.: US 2006/0210837 A1
(43) Pub. Date: Sep. 21, 2006

(54) Method of plating on a glass base plate, a method of manufacturing a disk substrate for a perpendicular magnetic recording medium, a disk substrate for a perpendicular magnetic recording medium, and a perpendicular magnetic recording medium

(75) Inventors: Hajime Kurihara, Minami-Alps City (JP); Youichi Tei, Matsumoto City (JP); Akira Iso, Minami-Alps City (JP)

Correspondence Address: ROSSI, KIMMS & McDOWELL LLP., P.O. BOX 826, ASHBURN, VA, 20146-0826, US

(73) Assignee: Fuji Electric Device, Shinagawa-ku (JP)

(21) Appl. No.: 11/374,669

(22) Filed: Mar. 13, 2006

Related U.S. Application Data
(63) Continuation-in-part of application No. 11/104,274, filed on Apr. 12, 2005.

(30) Foreign Application Priority Data
Apr. 16, 2004 (JP) JP 2004-121889
Oct. 25, 2004 (JP) JP 2004-309723
Apr. 8, 2005 (JP) JP 2005-112057

(51) Int. Cl. G11B 5/66; G11B 5/706

(52) U.S. Cl. 428/831; 428/848.8

(57) ABSTRACT

A method of plating on a glass base plate is disclosed. The method allows a plating film to be formed on a base plate composed of a glass material with excellent adhesivity and homogeneity by means of an electroless plating method, even to a thickness of 1 μm or more. Before forming the plating film by electroless plating, a series of surface treatments are conducted on the surface of the base plate composed of a glass material. The surface treatments comprises at least a glass activation treatment, a silane coupling agent treatment, a palladium catalyst treatment, a palladium bonding treatment, ab electroless plating to form a preliminary plating film having a thickness in the range of 0.02 μm to 0.5 μm, and an annealing at a temperature in the range of 200° C. to 350° C.

### CROSS REFERENCE TO RELATED APPLICATIONS

This application is based on, and claims priority to, Japanese Application No. 2005-112057, filed on Apr. 8, 2005, the contents of which are incorporated herein by reference. In addition, the present application is a continuation-in-part of U.S. patent application Ser. No. 11/104,274, filed on Apr. 12, 2005, the contents of which are incorporated herein by reference.

### BACKGROUND OF THE INVENTION

A. Field of the Invention

The present invention relates to a method of plating on a base plate composed of a glass material, a method of manufacturing a disk substrate for a perpendicular magnetic recording medium using the plating method, a disk substrate for a perpendicular magnetic recording medium manufactured by the manufacturing method, and a perpendicular magnetic recording medium using the disk substrate. In particular, the methods are beneficially applied to perpendicular magnetic recording media mounted on hard disk drives.

B. Description of the Related Art

In recent years, hard disk drives are often used for a memory device in computers or digital household appliances. In the case of a longitudinal magnetic recording system, a magnetic disk (hard disk) as a magnetic recording medium mounted on the hard disk drive is generally manufactured by the following procedure. A Ni—P layer is formed on the surface of a nonmagnetic substrate with a disk shape by an electroless plating method. The surface of the Ni—P layer is subjected to necessary smoothing and texturing treatments. Then, an underlayer of a nonmagnetic metal, a magnetic layer of a ferromagnetic alloy thin film, a protective layer, and other layers are sequentially formed on this surface by a sputtering method or other techniques.

Traditionally, an aluminum alloy has been used for the material of the nonmagnetic substrate. Recently, hard disk drives are rapidly evolving to have higher capacity and smaller size. In conjunction with this trend, a magnetic disk must have higher flatness, smaller diameter, and less thickness than previously. Conventional substrates of an aluminum alloy can hardly meet those requirements of the market. Thus, glass is being used for a substrate material.

A glass substrate is also desired to exhibit surface characteristics similar to those in an aluminum substrate by forming a Ni—P layer on the surface to obtain a magnetic disk exhibiting favorable performance. However, it is technically difficult to form a plating film with satisfactory adhesivity, homogeneity, and smoothness on a base plate composed of a glass material by an electroless plating method. To solve this problem, various methods have been proposed as pre- and post-treatments for the electroless plating.

In one example of such methods, electroless plating is conducted after a treatment using an aqueous solution containing palladium chloride and tin (II) chloride, and a treatment using an aqueous solution of alkali carbonate, an aqueous solution of alkali hydrogen carbonate, or a mixture of these aqueous solutions. (See Japanese Unexamined Patent Application Publication No. H1-176079.) In another method, electroless plating is conducted after a two-stage etching treatment using a chromic acid—sulfuric acid mixed solution and a nitric acid solution, an etching treatment using a strong alkaline solution, a sensitization treatment using dilute tin (II) chloride, and an activation treatment using a silver salt solution and a palladium salt solution. (See Japanese Unexamined Patent Application Publication No. S53-19932.) In another example, electroless plating is conducted after cleaning using a warm liquid of sulfuric acid and potassium dichromate, sensitization using tin (II) chloride acidified with hydrochloric acid, and activation using a palladium chloride solution. (See Japanese Unexamined Patent Application Publication No. S48-85614.) In still another method, electroless plating is conducted after alkali degreasing, etching using hydrofluoric acid, sensitization using a tin (II) chloride solution, and activation using a palladium chloride solution.

Japanese Unexamined Patent Application Publication No. H7-334841 proposes a method of electroless plating to form a Ni—P layer exhibiting sufficient adhesivity and smoothness on a glass substrate to obtain a favorable magnetic disk. In this method, electroless Ni—P plating is conducted after the pre-treatments of: sufficiently degreasing the glass substrate, etching to enhance anchoring effect, removing contamination that is produced in the etching process and adhered on the substrate surface, conducting a surface modulation process to chemically homogenize the substrate surface, conducting a sensitizing treatment, and conducting an activation treatment. The method preferably uses an aqueous solution containing hydrofluoric acid and potassium hydrofluoride for the etching solution, hydrochloric acid for removing the surface contaminant, and an aqueous solution containing sodium methoxide for the surface modulation.

Japanese Unexamined Patent Application Publication No. 2000-163743 proposes a method of forming an electroless Ni—P plating layer on a glass substrate for a magnetic disk. In this method, electroless Ni—P plating is conducted after sequential treatments on a glass substrate surface including: alkali degreasing treatment using a potassium hydroxide solution, etching treatment using hydrofluoric acid, treatment with warm pure water, silane coupling agent treatment, activator treatment using an aqueous solution of palladium chloride, and accelerator treatment using an aqueous solution of sodium hypophosphite. Heat treatment is conducted after the electroless Ni—P plating process.

Meanwhile, a perpendicular magnetic recording system is drawing attention in place of a conventional longitudinal magnetic recording system as a technology to attain high density of magnetic recording. In particular, a double layer perpendicular magnetic recording medium as disclosed in Japanese Patent Publication No. S58-91 is known as being suitable as a perpendicular magnetic recording medium for achieving high density recording. The double layer perpendicular magnetic recording medium is provided with a soft magnetic film called a soft magnetic backing layer under a magnetic recording layer that records information. The soft magnetic backing layer easily permeates the magnetic flux generated from the magnetic head and exhibits high saturation magnetic flux density Bs. The double layer perpendicular magnetic recording medium increases the intensity and gradient of the magnetic field generated by the magnetic head, improving recording resolution and increasing leakage flux from the medium.

A soft magnetic backing layer generally uses a film 200 nm to 500 nm thick formed by a sputtering method and composed of a Ni—Fe alloy, an Fe—Si—Al alloy, or an amorphous alloy of mainly cobalt. However, forming such a relatively thick film by a sputtering method is inappropriate from the viewpoints of manufacturing costs and mass productivity. To solve this problem, use of a soft magnetic film formed by an electroless plating method has been proposed for a soft magnetic backing layer. Japanese Unexamined Patent Application Publication No. H7-66034, for example, proposes to produce a NiFeP film by a plating method on a disk substrate of an aluminum alloy provided with a nonmagnetic NiP plating film and to use for a soft magnetic backing layer.

Digest of 9th Joint MMM/Intermag Conference, EP-12, p. 259 (2004) proposes a CoNiFeP plating film formed on a glass substrate. Digest of 9th Joint MMM/Intermag Conference, GD-13, p. 368 (2004) proposes a soft magnetic NiP plating film formed on an aluminum alloy disk substrate provided with a nonmagnetic Ni—P plating film.

If a soft magnetic backing layer forms a magnetic domain structure and generates a magnetic transition region called a magnetic domain wall, the noise called spike noise that is generated from this magnetic domain wall is known to degrade the performance as a perpendicular magnetic recording medium. Consequently, formation of the magnetic domain wall must be suppressed in a soft magnetic backing layer.

The NiFeP plating film mentioned previously is liable to form a magnetic domain wall. Thus, Journal of Magnetic Society of Japan (in Japanese), Vol. 28, No. 3, p. 289-294 (2004) discloses that the domain wall formation needs to be suppressed by forming a MnIr alloy thin film on the plating film by a sputtering method. Formation of a magnetic domain wall in the CoNiFeP plating film mentioned previously is disclosed to be suppressed by conducting plating in a magnetic field. A soft magnetic NiP plating film is said to generate no spike noise.

Japanese Unexamined Patent Application Publication No. H2-18710 proposes that the generation of spike noise is suppressed by forming a backing layer composed of cobalt or a cobalt alloy having coercivity Hc of 30 to 300 Oe so as to exhibit magnetic anisotropy along the circumferential direction of the disk substrate. While the backing layer in this method is formed by a dry process such as a sputtering method, an evaporation method, or the like, Japanese Unexamined Patent Application Publication No. H5-1384 proposes a method of forming a Co—B film that exhibits an Hc of at least 30 Oe and can suppress spike noise, by a plating method. The film is suggested to be possibly used for a soft magnetic backing layer.

The NiFeP plating film mentioned previously needs to suppress formation of a magnetic domain wall by forming a MnIr alloy thin film on the plating film employing a sputtering method to suppress spike noises. The requirement for adding a new film by means of a sputtering method for suppressing a magnetic domain wall detracts from the merit of the plating method in production costs and mass productivity.

In the CoNiFeP plating film mentioned previously, application of a homogeneous magnetic field to a substrate in a plating bath is difficult in a practical manufacturing process. The mass productivity is also liable to be impaired. An iron-containing plating film, exhibiting high Bs value, is favorable for a soft magnetic backing layer. However, since iron forms an ion of ionic valence of two and an ion of ionic valence of three, securing the stability of a plating bath generally is known to be difficult. Thus, the iron-containing plating film is also inferior in mass productivity.

As to a correlation between coercivity and magnetic domain wall formation of the soft magnetic backing layer formed by a plating method, it has been clarified that a coercivity value of the plating film of not smaller than 30 Oe cannot completely prevent the magnetic domain wall formation, although some tendency of suppression was observed. It has been further clarified that the increase of the coercivity deteriorates the read/write performance.

To solve these problems, a means has been proposed in Japanese Patent Application No. 2004-121889 entitled as “Disk substrate for a perpendicular magnetic recording medium and a perpendicular magnetic recording medium using the substrate,” which is one of the applications that corresponds to U.S. patent application Ser. No. 11/104,274, which is assigned to the same assignee as that of the present application. In the proposed means, mass-productivity is achieved and the generation of spike noise is avoided by forming a soft magnetic underlayer on a glass substrate by an electroless plating method, the soft magnetic underlayer being composed of a Co—Ni—P alloy film that contains phosphorus in the range of 3 at % to 20 at % of the film and cobalt of at least 45 at % in a proportion of number of atoms with respect to cobalt and nickel (Co/(Co+Ni)), and the thickness of the underlayer being in a range of 0.2 μm to 3 μm.

As described above, for a disk substrate of a magnetic recording medium mounted on a hard disk drive, a glass disk substrate using crystallized glass or chemically strengthened glass is used as well as an aluminum alloy substrate provided with a nonmagnetic NiP plating film. The glass substrates, having high strength, are mainly used in a magnetic recording medium of a mobile hard disk drive, which needs high shock resistance. The above-described electroless plating method for forming a soft magnetic plating film as a backing layer is effective to improve the productivity also in a glass disk substrate for a perpendicular magnetic recording medium.

The electroless plating films composed of a nonmagnetic Ni—P alloy have been practically used in an aluminum alloy substrate for hard discs, and the manufacturing method for mass production and the surface smoothing technique by polishing are well known. Consequently, in a glass substrate, too, if a nonmagnetic or soft magnetic plating layer exhibiting good adhesivity and satisfactory smoothness as an underlayer can be formed by means of an electroless plating method with a sufficient thickness for obtaining a well-performed magnetic disk, the glass substrate with an electroless plating film is very promising for a substrate of a magnetic recording medium from the view point of production costs.

For these reasons, various methods for conducting electroless plating on a glass substrate have been proposed as mentioned earlier. Among them, a method of using a silane coupling agent is effective. This method comprises processes of pre-treatment for the electroless plating including: subjecting the glass substrate to an acid treatment to modify the functional groups on the glass substrate surface to Si—OH groups (silanol groups), subsequently performing condensation reaction with the silane coupling agent to bond the silane coupling agent to the glass substrate, and dipping the substrate into a palladium catalyst solution to bond amino groups of the silane coupling agent to the palladium catalyst metal. An electroless plating film is formed on this catalyst metal surface. A type of silane coupling agent having two function-separated functional groups in a molecule is commercially available. The silane coupling agent performs hydrolysis in aqueous solution and has the functional groups (methoxyl groups, ethoxyl groups, or the like) that chemically bond to the Si—OH groups on the glass substrate surface through the condensation reaction. The silane coupling agent further contains functional groups (amino groups) that can bond to a metallic component, such as palladium, that is a catalyst for plating.

Unfortunately, the known methods of electroless plating, using the pre- and post-treatments as described above, have failed to form on a glass substrate a soft magnetic plating film of Co—Ni—P, Ni—P, Ni—Fe—P, or Co—Ni—Fe—P, and a nonmagnetic plating film of Ni—P with a sufficient thickness (in the range of 1 μm to 3 μm) for obtaining a favorable magnetic disk and with satisfactory adhesivity, homogeneity, and smoothness at that thickness.

The studies by the present inventors have revealed that some problems may arise in a method to form a plating film by means of electroless plating method after sequential pre-treatments of a silane coupling agent treatment (dipping into an aqueous solution of 3-aminopropyl ethoxy silane, for example) and a palladium catalyst treatment (dipping into a palladium chloride solution, for example). When bonding force at the interface between the silane coupling agent layer and the glass substrate is not strong enough, the stress in the film during the subsequent plating reaction causes blistering in the plating film during deposition, or even if the blistering is prevented in the plating process, in the next step of polishing, defects in adhesivity such as film peeling at an edge or micro film peeling are occasionally generated.

A method to improve poor adhesion is known in which the surface of the glass substrate is etched by acid treatment to increase surface roughness. Coarsening of the surface is, however, undesirable for enhancing recording density in a magnetic recording medium from the viewpoint of read/write performance.

An underlayer of Ni—P or the like is known to be formed by a sputtering method. It is, however, difficult to form an underlayer directly on a glass substrate since adhesivity between glass and metal is generally poor. To cope with this difficulty, a layer containing titanium or chromium, which among the metals exhibit relatively good adhesivity with glass, needs to be formed on the glass substrate, and an underlayer is formed on this adhesion layer of titanium or chromium. The titanium or chromium of the adhesion layer in this method does not exhibit enough adhesivity. So, when the underlayer or adhesion layer is thick, the adhesivity deteriorates due to the stress caused by the difference of expansion coefficients. Perpendicular magnetic recording media, which are being actively developed recently, need a relatively thick layer of soft magnetic backing layer in the range of 0.2 μm to 3.0 μm. The soft magnetic backing layer, when deposited by sputtering, involves a problem of degradation of adhesivity and in addition, a problem of high costs.

The present invention is directed to overcoming or at least reducing the effects of one or more of the problems set forth above.

### SUMMARY OF THE INVENTION

In view of the above problems, an object of the present invention is to provide a method of plating on a glass base plate. The method allows a plating film with a film thickness not smaller than 1 μm to be formed on a glass base plate by an electroless plating method with satisfactory adhesivity and homogeneity even on a base plate of glass material. Another object of the invention is to provide a method of manufacturing a disk substrate for a perpendicular magnetic recording medium having a soft magnetic underlayer that satisfies magnetic property, thickness, adhesivity, homogeneity, and smoothness of a plating film required by a soft magnetic backing layer of a hard disk as a perpendicular magnetic recording medium by forming a soft magnetic plating film on a glass substrate with a disk shape employing the method of plating according to the invention. Still other objects are to provide a disk substrate for a perpendicular magnetic recording medium manufactured by the method of manufacturing a disk substrate, and to provide a perpendicular magnetic recording medium using such a disk substrate.

To accomplish these and other objects, a method of plating on a glass base plate according to the invention comprises a series of treatments sequentially conducted on a surface of a base plate composed of a glass material, the series of treatments including at least a step of glass activation treatment, a step of silane coupling agent treatment, a step of palladium catalyst treatment, a step of palladium bonding treatment, a step of forming a preliminary plating film having a thickness in a range of 0.02 μm to 0.5 μm by means of an electroless plating method, and a step of annealing at a temperature in a range of 200° C. to 350° C.; and a process of electroless plating on the preliminary plating film.

A method of manufacturing a disk substrate for a perpendicular magnetic recording medium according to the invention forms a soft magnetic plating film on a glass substrate with a disk shape using the method of plating on a glass base plate as described above. The method comprises a series of treatments sequentially conducted on a surface of a glass substrate with a disk shape, the series of treatments including at least a step of glass activation treatment, a step of silane coupling agent treatment, a step of palladium catalyst treatment, a step of palladium bonding treatment, a step of forming a preliminary plating film having a thickness in a range of 0.02 μm to 0.5 μm by means of an electroless plating method, and a step of annealing at a temperature in a range of 200° C. to 350° C.; and a process of forming a soft magnetic plating film on the preliminary plating film by means of an electroless plating method.

A disk substrate for a perpendicular magnetic recording medium manufactured by the manufacturing method according to the invention comprises a glass substrate with a disk shape, an adhesion layer composed of a silane coupling agent formed on the glass substrate, a catalyst layer composed of a catalyst metal formed on the adhesion layer, a buffer layer composed of a preliminary plating film having a thickness in a range of 0.02 μm to 0.5 μm that is formed on the catalyst layer by means of an electroless plating method and subjected to an annealing treatment, and a soft magnetic underlayer composed of a soft magnetic plating film that is formed on the buffer layer by means of an electroless plating method and utilized as at least a part of a soft magnetic backing layer for perpendicular magnetic recording.

Advantageously, the glass substrate is composed of chemically strengthened glass or crystallized glass, the buffer layer is composed of a soft magnetic alloy or a nonmagnetic alloy, and the soft magnetic underlayer has a thickness in a range of 0.2 μm to 3 μm.

A perpendicular magnetic recording medium according to the invention comprises at least a nonmagnetic seed layer, a magnetic recording layer, and a protective layer sequentially formed on the disk substrate for a perpendicular magnetic recording medium according to the invention, wherein the soft magnetic underlayer of the disk substrate is utilized as at least a part of a soft magnetic backing layer for the magnetic recording layer.

In this invention, if a thickness of the buffer layer is less than 0.02 μm and the annealing process is continued until sufficient adhesivity is obtained, the buffer layer suffers from cracks in the film. If the buffer layer is thicker than 0.5 μm, it takes much time to obtain enough adhesivity by annealing and such a thickness is unsuitable for mass production. If the buffer layer is thicker than 0.5 μm and made from a magnetic material, the tensile stress by the annealing causes magnetic anisotropy vertical to the substrate surface. The vertical magnetic anisotropy unfavorably affects the magnetic property of the soft magnetic underlayer.

According to the invention, a buffer layer is formed that has a thickness of 0.02 μm to 0.5 μm by an electroless plating method on the surface of a glass substrate bonded with catalyst metal using a silane coupling agent. The buffer layer is annealed at a relatively high temperature of 200° C. to 350° C. to produce a strong bond between the buffer layer and the glass substrate. After that, a soft magnetic underlayer is formed on the buffer layer by an electroless plating method. Thus, a disk substrate for perpendicular magnetic recording medium is obtained that has sufficient adhesivity between the soft magnetic underlayer formed by electroless plating and the glass substrate. A perpendicular magnetic recording medium using such a disk substrate is also provided.

A method of plating on a glass base plate according to the invention allows even a thick plating film of 1 μm or more to be formed on a base plate composed of a glass material by an electroless plating method with good adhesivity and homogeneity.

A method of manufacturing a disk substrate for a perpendicular magnetic recording medium according to the invention allows a soft magnetic plating film that satisfies magnetic property, film thickness, adhesivity, and homogeneity required by a soft magnetic backing layer to be formed on a glass substrate by means of an electroless plating method.

According to the present invention, the soft magnetic backing layer of a perpendicular magnetic recording medium is formed on a glass substrate by an electroless plating method that achieves high productivity. Therefore, even a thick film can be manufactured in a remarkably lower cost as compared with manufacture by a sputtering method, for example.

The following describes some preferred embodiments to manufacture a disk substrate for a perpendicular magnetic recording medium applying a method of plating on a glass base plate according to the invention. The method of plating on a glass base plate according to the invention is, however, not limited to this application. The same effects are obtained when a nonmagnetic or magnetic plating film is formed by an electroless plating method on a base plate of a glass material in general, with a thickness of at least 1 μm and with good adhesivity and homogeneity.

The base plates of a glass material in general include for example, glass for flat panel displays such as liquid crystal, PDP, FED, EL, and the like, glass for information devices such as copiers, and further, glass for optical communication devices, cars, medical equipment, and building materials.

### BRIEF DESCRIPTION OF THE DRAWINGS

The foregoing advantages and features of the invention will become apparent upon reference to the following detailed description and the accompanying drawings, of which:

FIG. 1 shows a procedure in a method of manufacturing a disk substrate for a perpendicular magnetic recording medium of an embodiment according to the invention;

FIG. 2 is a schematic sectional view of a disk substrate for a perpendicular magnetic recording medium of an embodiment according to the invention;

FIG. 3 is a schematic sectional view of a perpendicular magnetic recording medium of an embodiment according to the invention;

FIG. 4 shows an M-H loop of a disk substrate for a perpendicular magnetic recording medium of Example 1 measured by a VSM; and

FIG. 5 shows an M-H loop of a disk substrate for a perpendicular magnetic recording medium of Comparative Example 3 measured by a VSM.

The figures employ the following reference numbers:
1 glass substrate
2 adhesion layer
3 catalyst layer
4 buffer layer
5 soft magnetic underlayer
10 disk substrate for a perpendicular magnetic recording medium
20 nonmagnetic seed layer
30 magnetic recording layer
40 protective layer
S1 alkali degreasing treatment
S2 glass activation treatment
S3 silane coupling agent treatment
S4 palladium catalyst treatment
S5 palladium bonding treatment
S6 electroless plating
S7 annealing treatment
S8 electroless plating

### DETAILED DESCRIPTION OF SPECIFIC EMBODIMENTS

Embodiment of a Disk Substrate for a Perpendicular Magnetic Recording Medium

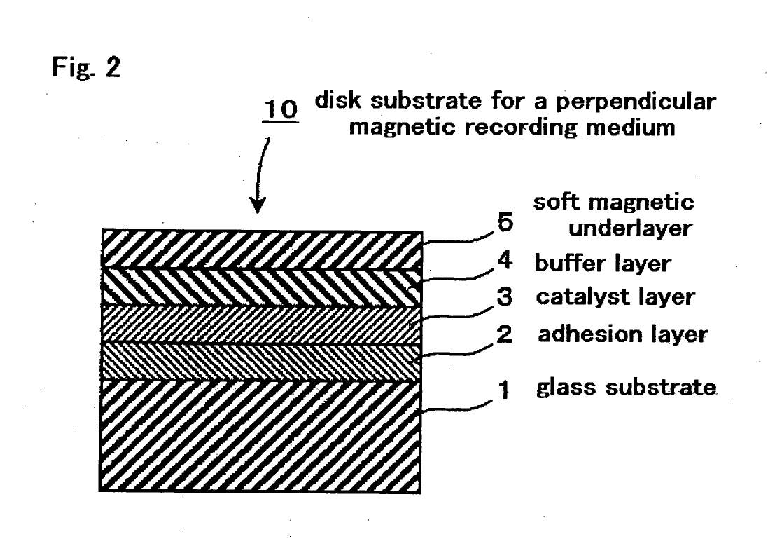

As shown in FIG. 2, disk substrate 10 for a perpendicular magnetic recording medium of an embodiment of the invention comprises glass substrate 1 with a disk shape, adhesion layer 2 composed of a silane coupling agent formed on glass substrate 1, catalyst layer 3 composed of catalyst metal formed on adhesion layer 2, and buffer layer 4 composed of a plating film having a thickness in a range of 0.02 μm to 0.5 μm that is formed on catalyst layer 3 by means of an electroless plating method and subjected to an annealing treatment, and soft magnetic underlayer 5 composed of a soft magnetic plating film that is formed on buffer layer 4 by means of an electroless plating method and utilized as at least a part of a soft magnetic backing layer for perpendicular magnetic recording. Though not shown in the figure, adhesion layer 2, catalyst layer 3, buffer layer 4, and soft magnetic underlayer 5 may also be provided on the other side of glass substrate 1.

Soft magnetic underlayer 5 can be composed of a soft magnetic plating film of a Co—Ni—P alloy, a Ni—Fe—P alloy, a Co—Ni—Fe—P alloy, or a Ni—P alloy (phosphorus concentration less than 5 at %). When soft magnetic underlayer 5 is composed of a Co—Ni—P alloy in particular, soft magnetic underlayer 5 is preferably composed of a Co—Ni—P alloy film containing phosphorus in a range of 3 at % to 20 at % and cobalt of at least 45 at % in a proportion of number of atoms of cobalt and nickel (Co/(Co+Ni)) and has a thickness in a range of 0.2 μm to 3 μm, as proposed in Japanese Patent Application No. 2004-309723 entitled as “Disk substrate for a perpendicular magnetic recording medium and a perpendicular magnetic recording medium using the disk substrate”, which is one of the applications that corresponds to U.S. patent application Ser. No. 11/104,274, which is assigned to the same assignee as that of the present application. Soft magnetic underlayer 5 needs a thickness of at least 0.2 μm to function as a soft magnetic backing layer for a perpendicular magnetic recording medium capable of high density recording, while the thickness is desired to be at most 3 μm in view of productivity.

With respect to the composition of soft magnetic underlayer 5, a phosphorus concentration below 3 at % hardly forms a stable electroless plating film, while a phosphorus concentration over 20 at % results in a too low value of saturation magnetic flux density Bs and cannot perform a function as a soft magnetic backing layer. Furthermore, a cobalt concentration lower than 45 at % in a proportion of number of atoms of cobalt and nickel (Co/(Co+Ni)) is not appropriate since the value of saturation magnetic flux density Bs cannot be maintained sufficiently high and the saturation magnetostriction constant becomes negative and a large absolute value. Although an upper limit of the cobalt concentration is not strictly limited to a special value, a cobalt concentration over 90 at % in a proportion of number of atoms of cobalt and nickel (Co/(Co+Ni)) tends to make the CoNi alloy take an hcp structure having a large crystalline magnetic anisotropy constant and to increase coercivity, both of which are unfavorable. The composition preferably contains at least 10 at % of nickel in a proportion of number of atoms of cobalt and nickel (Ni/(Co+Ni)) to stably form an fcc structure.

Buffer layer 4 can be composed of the soft magnetic alloy used in soft magnetic underlayer 5 described above. Alternatively, a nonmagnetic Ni—P alloy (phosphorus concentration larger than 5 at %) exhibiting good corrosion resistance can be employed in buffer layer 4.

Embodiment of a Method of Manufacturing a Disk Substrate for a Perpendicular Magnetic Recording Medium

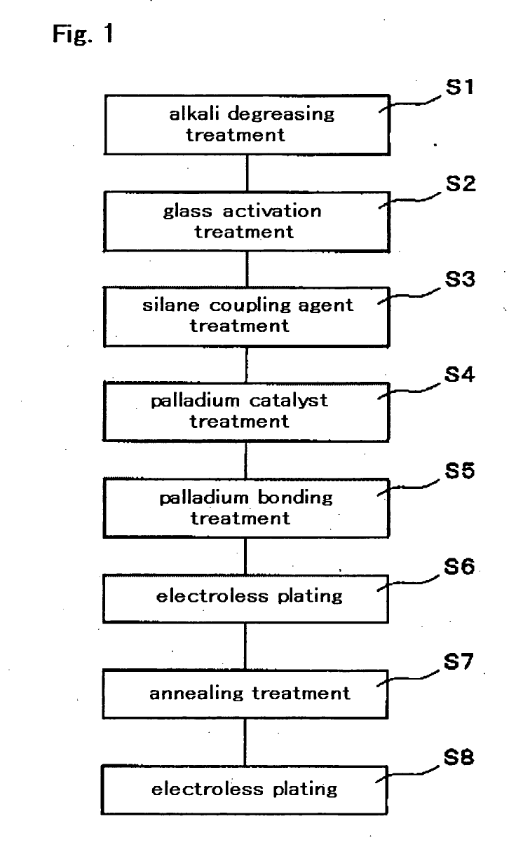

A method of manufacturing disk substrate 10 for a perpendicular magnetic recording medium in this embodiment comprises, as shown in FIG. 1, a step of alkali degreasing treatment S1, a step of glass activation treatment S2, a step of silane coupling agent treatment S3, a step of palladium catalyst treatment S4, and a step of palladium bonding treatment S5 sequentially conducted on the surface of a glass substrate 1 as a base plate of a glass material, and a step of electroless plating S6 forming a preliminary plating film having a thickness in a range of 0.02 μm to 0.5 μm by means of an electroless plating method, and a step of annealing S7 at a temperature in a range of 200° C. to 350° C.; and a process of electroless plating S8 on the preliminary plating film to form a soft magnetic plating film.

A method of plating on a glass substrate according to the invention can be employed in various applications as described previously, by changing the composition of the electroless plating bath used in the electroless plating process S8. The following describes each step of this embodiment.

Step of Alkali Degreasing Treatment S1

The first step of this aspect of embodiment is a step of alkali degreasing treatment S1 on a surface of glass substrate 1. The step of alkali degreasing treatment S1 can be conducted in one stage using an aqueous solution of a basic inorganic compound. However, the step is preferably carried out in two stages including a treatment using an alkaline detergent solution and a treatment using an aqueous solution of a basic inorganic compound.

An alkaline detergent used in this step shows a pH value in a range of 9.0 to 11.0 in a solution thereof, and specifically includes an anion type surface active agent. The alkaline detergent solution preferably contains from 1 to 10 wt % of alkaline detergent. The treatment using an alkaline detergent solution is preferably conducted by dipping glass substrate 1 in an alkaline detergent solution. As required, agitation of the detergent solution or irradiation of ultrasonic wave may be used simultaneously. This treatment is generally carried out at a temperature of 20 to 70° C. and for 1 to 10 minutes.

Basic inorganic compounds used in this step include NaOH, KOH, LiOH, and Ba(OH)₂. An aqueous solution of the basic inorganic compound contains a basic inorganic compound preferably in the range of 1 to 15 wt %, more preferably in the range of 5 to 10 wt %, and a pH value is preferably in the range of 13.0 to 14.0. A treatment using an aqueous solution of a basic inorganic compound is preferably conducted by dipping glass substrate 1 in an aqueous solution of a basic inorganic compound. As required, agitation of the aqueous solution or irradiation of ultrasonic wave to the aqueous solution may be used simultaneously. This treatment is generally carried out at a temperature of 20 to 70° C. and for 1 to 10 minutes. By conducting the step of alkali degreasing treatment S1, organic thin films or particles adhering on glass substrate 1 are removed, to clean the surface of glass substrate 1.

Step of Glass Activation Treatment S2

Next, a step of glass activation treatment S2 is conducted. The step of glass activation treatment S2 peels off inactive oxide films existing on the surface of glass substrate 1 and, at the same time, modifies the functional groups on the surface of glass substrate 1 into silanol groups (Si—OH) that are reactive, thereby to activate the surface of glass substrate 1 for the reaction with a silane coupling agent that will be described later. The step of glass activation treatment S2 is conducted by dipping the glass substrate 1 into an aqueous solution of diluted acid such as hydrofluoric acid of 0.001 wt % to 1 wt %. This treatment is generally carried out at a temperature of 20 to 50° C. and for 1 to 10 minutes.

Step of Silane Coupling Agent Treatment S3

Next, a step of silane coupling agent treatment S3 is conducted on glass substrate 1 that has been subjected to the glass activation treatment S2, to form adhesion layer 2 composed of a silane coupling agent on glass substrate 1. Silane coupling agents that can be used in this step are alkyl trialkoxysilanes (so-called amino type silane coupling agent) that have a nitrogen substituent (amino group) on an alkyl group, preferably including the compounds having a structure represented by the following general formula (I).
(CₘH₂ₘ₊₁O)₃Si(CH₂)ₙNHR (I)
where R is selected from H, CₚH₂ₚNH₂, CONH₂, and C₆H₅, and each of m, n, and p represents a positive integer. Preferably, m is 1 or 2, n is an integer from 2 to 4, and p is an integer from 2 to 4.

More preferably, a compound selected from the compounds of (II) to (IX) or a mixture of those compounds is used.
(CH₃O)₃SiC₃H₆NH₂ (II)

[3-aminopropyl trimethoxysilane]
(C₂H₅O)₃SiC₃H₆NH₂ (III)

[3-aminopropyl triethoxysilane]
(CH₃O)₃SiC₃H₆NHC₂H₄NH₂ (IV)

[N-(2-aminoethyl)-3-aminopropyl trimethoxysilane]
(C₂H₅O)₃SiC₃H₆NHC₂H₄NH₂ (V)

[N-(2-aminoethyl)-3-aminopropyl triethoxysilane]
(CH₃O)₃SiC₃H₆NHC₆H₅ (VI)

[N-phenyl-3-aminopropyl trimethoxysilane]
(C₂H₅O)₃SiC₃H₆NHCONH₂ (VI)

[3-ureidopropyl triethoxysilane]
(C₂H₅O)₃SiC₃H₆N═C(C₄H₉)CH₃ (VIII)

[3-triethoxysilyl-N-(1,3-dimethylbutylidene)-propylamine]
(CH₃O)₂(CH₃)SiC₃H₆NHC₂H₄NH₂ (IX)

[N-(2-aminoethyl)-3-aminopropylmethyl dimethoxysilane]

A silane coupling agent is generally used in an aqueous solution of 0.1 to 4.0 wt %. In the case of a silane coupling agent exhibiting low solubility in water (for example, the compound of formula (VII)) may be used by dissolving in an aqueous solution of acetic acid of 0.1 to 2.0 wt % or in a mixed solvent of water—alcohol, e.g., methanol, ethanol, or the like. The mixed solvent can further contain acetic acid.

The step of silane coupling agent treatment S3 is preferably carried out by dipping glass substrate 1 in a silane coupling agent solution. As required, agitation of the solution or irradiation of ultrasonic wave to the solution may be used simultaneously. This treatment is generally conducted at a temperature of 20 to 30° C. and for 1 to 10 minutes. Adhesion layer 2 formed of a silane coupling agent has a thickness in the range of 10 to 50 nm.

As shown in scheme 1 below, the alkoxyl groups in the silane coupling agent are transformed to silanol groups through hydrolysis with the water component of the aqueous solution or the water-containing solution, and then the silane coupling agent partially condenses to a state of oligomers. The silane coupling agent in this state adheres strongly through hydrogen bonds with the silanol groups that are produced on the surface of glass substrate 1 in the step of glass activation treatment S2. 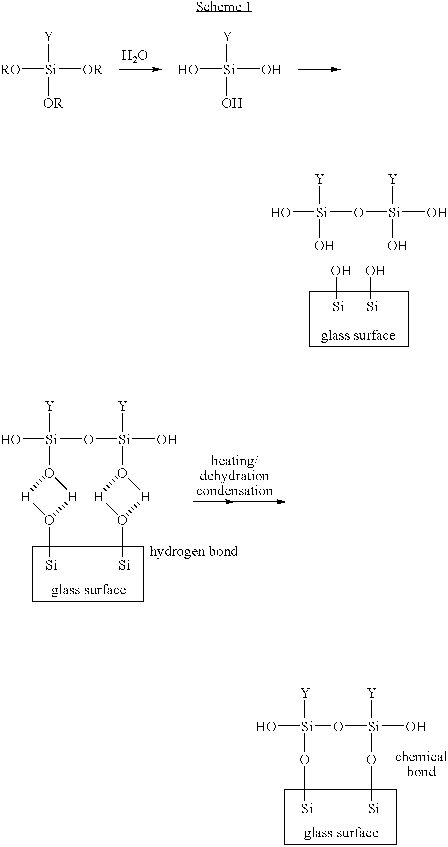
Step of Palladium Catalyst Treatment S4

Next, a step of palladium catalyst treatment S4 is conducted on glass substrate 1 having adhesion layer 2 of a silane coupling agent formed thereon. The step of palladium catalyst treatment S4 is carried out by dipping glass substrate 1 with adhesion layer 2 formed thereon in an aqueous solution containing palladium ions of valence 2. Palladium chloride (PdCl₂), for example, can be used for an aqueous solution containing palladium ions of valence 2. The reaction between the palladium ion and the N-functional group (amino group, imino group, ureido group, or the like) of the silane coupling agent can be promoted by adding an alkaline compound such as NaOH or KOH into the aqueous solution of palladium chloride. This step is preferably carried out using an aqueous solution containing 0.01 to 1.0 wt % of palladium ions in a PdCl₂-converted proportion and 0.01 to 1.0 wt % of alkaline compound in a KOH-converted proportion. This treatment is generally carried out at a temperature in the range of 20 to 30° C. and for 1 to 10 minutes. This step bonds the palladium ions to the N-functional groups of the silane coupling agent through a coordinate bond or the like, forming catalyst layer 3 that functions as a catalyst for the electroless plating. Catalyst layer 3 has a thickness of 1 to 10 nm.

Step of Palladium Bonding Treatment S5

Subsequently, a step of palladium bonding treatment S5 is conducted. This step is preferably carried out by dipping glass substrate 1 having catalyst layer 3 formed thereon into an aqueous solution of hypophosphorous acid (H₃PO₂). By the treatment in the aqueous solution of hypophosphorous acid, chlorine dissociates from palladium that forms a complex compound with the chlorine and a strongly bonded condition is established between the amino group of the silane coupling agent and the palladium as a catalyst component. During the process, the excessive free palladium is removed. The aqueous solution of hypophosphorous acid preferably contains 0.1 to 1.0 wt % of hypophosphorous acid. The step is generally carried out at a temperature of 20 to 30° C. and for 1 to 5 minutes.

Step of Electroless Plating S6

Next, a step of electroless plating S6 is conducted on glass substrate 1 on which the palladium bonding treatment S6 has been conducted, forming buffer layer 4. This step is preferably carried out by dipping glass substrate 1 in an electroless plating solution. Buffer layer 4 must have a thickness in a range of 0.02 to 0.5 nm in order to enhance adhesivity and homogeneity of the plating film.

Step of Annealing Treatment S7

Then, a step of annealing treatment S7 is conducted on glass substrate 1 having buffer layer 4 at a temperature in a range of 200° C. to 350° C. This step improves adhesivity of buffer layer 4 to glass substrate 1. This step actuates the dehydration condensation between the silanol group on the surface of glass substrate 1 in an adhesion condition through a hydrogen bond and the silanol group of the silane coupling agent of adhesion layer 2, and forms a strong chemical bond (covalent bond) between them. Thus, improvement is achieved in the adhesivity between glass substrate 1 and adhesion layer 2, which in turn improves adhesivity between glass substrate 1 and buffer layer 4. In order to avoid oxidation of buffer layer 4, this step is preferably conducted in an oxygen-free condition, for example, in an inert gas atmosphere such as nitrogen, helium, or argon, or in vacuum.

If a thickness of buffer layer 4 is less than 0.02 μm, more specifically not thicker than 0.01 μm, and the annealing process is continued until sufficient adhesivity is developed, buffer layer 4 suffers from cracks in the film. If buffer layer 4 is thicker than 0.5 μm, it takes much time to attain enough adhesivity by annealing and such a thickness is unsuitable for mass production.

Although the annealing time is effectively shortened by raising the temperature, glass generally changes to a brittle state at about 400° C., depending on the type of the glass. Accordingly, the upper limit of the annealing is set at 350° C. The optimal temperature and duration of the annealing treatment depend on the type and composition of the plating alloy. In any event, in buffer layer 4 thicker than 0.5 μm and made from a magnetic material, the tensile stress due to the annealing treatment causes magnetic anisotropy vertical to the substrate surface. The vertical magnetic anisotropy unfavorably affects the magnetic property of soft magnetic underlayer 5.

Step of Electroless Plating S8

Then, soft magnetic underlayer 5 is formed by conducting electroless plating treatment S8 on glass substrate 1 on which the annealing treatment S7 has been conducted. This step is carried out by dipping glass substrate 1 in an electroless plating liquid. Plating films of various compositions can be formed by changing the electroless plating liquid. The soft magnetic underlayer needs to be formed with a thickness of at least 0.2 μm to function as a soft magnetic backing layer, and is favorably at most 3 μm in view of productivity. Because soft magnetic underlayer 5 formed in this step is utilized as a soft magnetic backing layer, when soft magnetic underlayer 5 is composed of a Co—Ni—P alloy, soft magnetic underlayer 5 is preferably composed of a Co—Ni—P alloy film containing phosphorus in a range of 3 at % to 20 at % and cobalt of at least 45 at % in a proportion of number of atoms of cobalt and nickel (Co/(Co+Ni)) and has a thickness in a range of 0.2 μm to 3 μm.

After forming soft magnetic underlayer 5 by an electroless plating method, a polishing treatment may be conducted for smoothing the surface of soft magnetic underlayer 5. The surface of soft magnetic underlayer 5 is effectively polished and smoothed using free abrasive. The polishing can be conducted for example, using a double head type buffing machine with polishing pads of urethane foam and feeding the abrasive of suspended aluminum oxide or colloidal silica.

Embodiment of a Perpendicular Magnetic Recording Medium

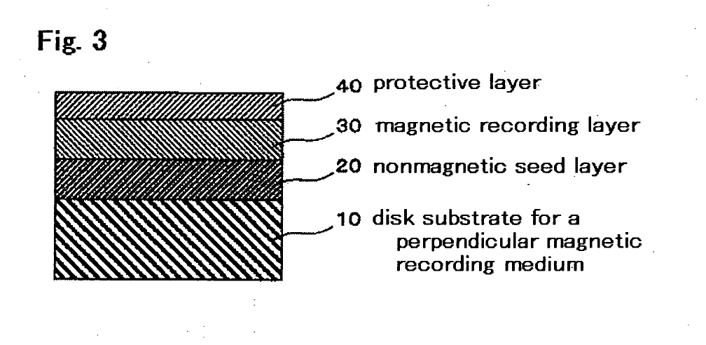

The following describes an aspect of embodiment according to the invention of a perpendicular magnetic recording medium using disk substrate 10 for a perpendicular magnetic recording medium of the embodiment described above. As shown in FIG. 3, a perpendicular magnetic recording medium of this aspect of invention has a structure comprising at least nonmagnetic seed layer 20, magnetic recording layer 30, and protective layer 40 sequentially formed on disk substrate 10 of FIG. 2 for a perpendicular magnetic recording medium. Though not shown in FIG. 3, nonmagnetic seed layer 20, magnetic recording layer 30, and protective layer 40 can also be formed on the other side of disk substrate 10 of a perpendicular magnetic recording medium.

Nonmagnetic seed layer 20 can be composed of a material to control the crystal alignment and the grain size of the magnetic recording layer 30 favorably, without any special limitation. When magnetic recording layer 30 is a perpendicular magnetization film composed of a CoCrPt alloy, for example, nonmagnetic seed layer 20 can be composed of a CoCr alloy, titanium or a titanium alloy, or ruthenium or a ruthenium alloy. When magnetic recording layer 30 is a so-called laminated perpendicular magnetization film composed of laminated cobalt alloy layers and platinum or palladium layers, nonmagnetic seed layer 20 can be composed of platinum or palladium. A pre-seed layer or an intermediate layer can be provided on or under nonmagnetic seed layer 20 without obstructing the effects of the invention.

Magnetic recording layer 30 can be composed of any material that allows recording and reproduction in a perpendicular magnetic recording medium. The materials can be selected from the above-mentioned perpendicular magnetization films composed of the CoCrPt alloy, a CoCrPt alloy containing an oxide, or a so-called perpendicular magnetization film comprising layers of a cobalt alloy and platinum or palladium.

Protective layer 40 is a thin film composed mainly of carbon, for example. Protective layer 40 can also be composed of the thin film of mainly carbon and a liquid lubricant layer formed by applying a liquid lubricant such as perfluoropolyether on the carbon thin film.

Nonmagnetic seed layer 20, magnetic recording layer 30, and protective layer 40 can be formed by a thin film formation technique selected from sputtering, CVD, vacuum evaporation, plating, and the like.

A perpendicular magnetic recording medium manufactured as described above has the favorable read/write performance as a double layer perpendicular magnetic recording medium since soft magnetic underlayer 5 in disk substrate 10 acts as a soft magnetic backing layer. In addition, the soft magnetic backing layer is formed by an electroless plating method that exhibits high productivity. Therefore, the medium can be manufactured at a very low cost because the backing layer need not be formed by an expensive method of sputtering, for example.

### EXAMPLES

Some specific examples of the above-described aspects of embodiment of a disk substrate for a perpendicular magnetic recording medium and a manufacturing method therefor according to the invention will be described, as well as comparative examples, in the following.

### Example 1

A strengthened glass substrate (trade name “N5”, manufactured by HOYA Corporation) was used for a glass substrate 1, and the following treatments were conducted in the steps (1) through (8).

(1) In the step S1, alkali degreasing treatment was carried out by dipping in an aqueous solution of alkaline detergent with a concentration of 1.5 wt % at a temperature of 50° C. for 3 minutes, and by dipping in an aqueous solution of KOH with a concentration of 7.5 wt % at a temperature of 50° C. for 3 minutes.

(2) In the step S2, glass activation treatment was carried out by dipping in a aqueous solution of H₂SO₄ with a concentration of 1.0 wt % at a temperature of 20° C. for 3 minutes and subsequently dipping in an aqueous solution of HF with a concentration of 1.0 wt % at a temperature of 20° C. for 3 minutes.

(3) In the step S3, silane coupling agent treatment was carried out to form adhesion layer 2 by dipping in an aqueous solution of 3-aminopropyl triethoxysilane (a compound of Formula (III)) with a concentration of 1.0 wt % at a temperature of 20° C. for 3 minutes.

(4) In the step S4, palladium catalyst treatment was carried out to form catalyst layer 3 by dipping in a mixed aqueous solution of PdCl₂ with a concentration of 1.0 wt % and NaOH with a concentration of 0.2 wt % at a temperature of 20° C. for 3 minutes.

(5) In the step S5, palladium bonding treatment was carried out by dipping in an aqueous solution of H₃PO₂ with a concentration of 1.0 wt % at a temperature of 20° C. for 3 minutes.

(6) In the step S6, buffer layer 4 composed of a CoNiP alloy film 0.02 μm thick was formed by means of an electroless plating method using a plating bath shown in Table 1.

TABLE 1
Plating bath

| | |
|---|---|
| nickel sulfate | 13 g/litter |
| cobalt sulfate | 14 g/litter |
| sodium hypophosphite | 25 g/litter |
| sodium citrate | 60 g/litter |
| boric acid | 30 g/litter |
| pH 8 ± 0.2 | adjusted by NaOH and H₂SO₄ |
| liquid temperature | 80 ± 2° C. |

(7) In the step S7, annealing treatment for buffer layer 4 was conducted in an oxygen-free atmosphere at 300° C. for 30 minutes.

(8) In the step S8, soft magnetic underlayer 5 composed of a CoNiP alloy 2.8 μm thick was formed on buffer layer 4 by means of an electroless plating method using the plating bath of Table 1 again.

Through the above steps, disk substrate 10 for a perpendicular magnetic recording medium as shown in FIG. 1 was manufactured.

### Example 2

The steps were conducted in the same manner as in Example 1 except that the thickness of buffer layer 4 was changed to 0.2 μm and the annealing temperature was changed to 200° C.

### Example 3

The steps were conducted in the same manner as in Example 1 except that the thickness of buffer layer 4 was changed to 0.2 μm and the annealing temperature was changed to 280° C.

### Example 4

The steps were conducted in the same manner as in Example 1 except that the thickness of buffer layer 4 was changed to 0.2 μm and the annealing temperature was changed to 350° C.

### Example 5

The steps were conducted in the same manner as in Example 1 except that the thickness of buffer layer 4 was changed to 0.5 μm. The annealing temperature was 300° C.

### Example 6

The steps were conducted in the same manner as in Example 1 except that the thickness of buffer layer 4 was changed to 0.5 μm and the annealing temperature and time were changed to 350° C. and 60 minutes.

### Comparative Example 1

The steps were conducted in the same manner as in Example 1 except that buffer layer 4 was not provided, that is, the steps S6 and S7 were omitted.

### Comparative Example 2

The steps were conducted in the same manner as in Example 1 except that the thickness of buffer layer 4 was changed to 0.01 μm.

### Comparative Example 3

The steps were conducted in the same manner as in Example 1 except that the thickness of buffer layer 4 was changed to 0.6 μm.

### Comparative Example 4

The steps were conducted in the same manner as in Example 1 except that the thickness of buffer layer 4 was changed to 0.2 μm and the annealing temperature was changed to 180° C.

### Comparative Example 5

The steps were conducted in the same manner as in Example 1 except that the thickness of buffer layer 4 was changed to 0.2 μm and the annealing temperature was changed to 400° C.

Evaluation

On ten samples of disk substrates 10 for a perpendicular magnetic recording medium manufactured in every examples of Examples 1 through 6 and Comparative Examples 1 through 5, evaluations were conducted about the external appearance by visual observation, the adhesivity of a plating film by the cross-cut peeling test (JIS (Japanese Industrial Standards) K 5600-5-6), and the magnetic property of a plating film by a VSM (vibrating sample type magnetometer). The test results as well as main conditions in the Examples and Comparative Examples are given in Table 2.

TABLE 2

| | | | | thickness of | | | |
|---|---|---|---|---|---|---|---|
| | buffer layer | annealing | annealing | plating layer | external | | magnetic |
| | thickness | temperature | time | *4 | appearance | adhesivity | property |
| | (μm) | (° C.) | (min) | (μm) | *1 | *2 | *3 |
| Example 1 | 0.02 | 300 | 30 | 2.8 | ◯ | ◯ | ◯ |
| Example 2 | 0.2 | 200 | 30 | 2.8 | ◯ | ◯ | ◯ |
| Example 3 | 0.2 | 280 | 30 | 2.8 | ◯ | ◯ | ◯ |
| Example 4 | 0.2 | 350 | 30 | 2.8 | ◯ | ◯ | ◯ |
| Example 5 | 0.5 | 300 | 30 | 2.8 | ◯ | ◯ | ◯ |
| Example 6 | 0.5 | 350 | 60 | 2.8 | ◯ | ◯ | ◯ |
| Comp Ex 1 | none | — | — | 2.8 | X | X | ◯ |
| Comp Ex 2 | 0.01 | 300 | 30 | 2.8 | crack *5 | — | ◯ |
| Comp Ex 3 | 0.6 | 300 | 30 | 2.8 | X | X | X |
| Camp Ex 4 | 0.2 | 180 | 30 | 2.8 | X | X | ◯ |
| Comp Ex 5 | 0.2 | 400 | 30 | 2.8 | crack *5 | — | X |

*1
◯: blistering occurred in none out of ten samples,
X: blistering occurred in at least one sample out of ten samples.
*2
◯: peeling occurred in none out of ten samples,
X: peeling occurred in at least one sample out of ten samples.
*3
◯: soft magnetic property was established
X: large vertical magnetic anisotropy was detected
*4
thickness of the soft magnetic plating layer
*5
crack was observed in the buffer layer

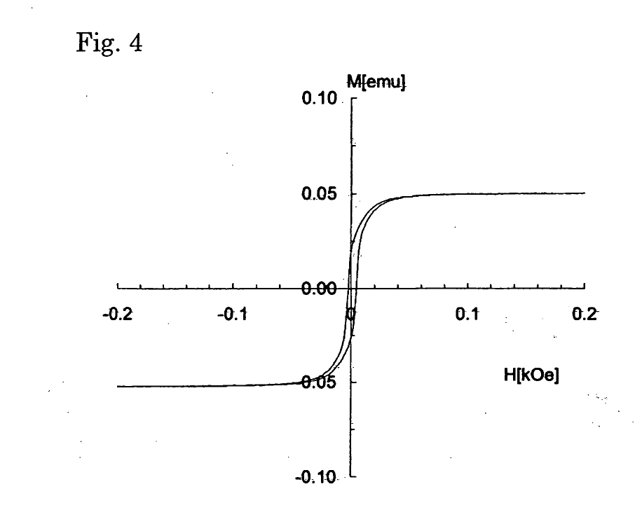

As is apparent from the results in Examples 1 through 6 in Table 2, blistering in the film was not detected by visual observation, and peeling of the film did not occur in the evaluation of adhesivity by the cross-cut peeling tests. For use in a perpendicular magnetic recording medium, the CoNiP film formed by electroless plating needs to exhibit soft magnetic property. Accordingly, the magnetic property was measured by a VSM, resulting in a satisfactory soft magnetic property. FIG. 4 shows an M-H loop (a magnetization curve) of a sample of Example 1 measured by the VSM.

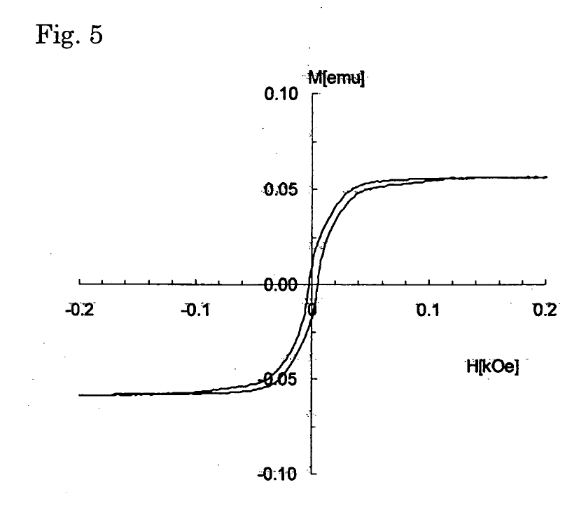

On the other hand, in Comparative Example 1, which did not include buffer layer 4, the blistering and peeling in the film occurred although the magnetic property was satisfied. In Comparative Example 2, in which the thickness of buffer layer 4 was thinner than 0.02 μm, cracks were generated in the buffer layer 4 by the annealing treatment, though magnetic property was satisfied. In Comparative Example 3, in which the thickness of buffer layer 4 was larger than 0.5 μm, blistering and peeling of the film occurred and, in addition, magnetic anisotropy vertical to the substrate surface also occurred in buffer layer 4 due to tensile stress caused by annealing treatment. Thus, magnetic performance of soft magnetic underlayer 5 was damaged. FIG. 5 shows an M-H loop of Comparative Example 3 measured by the VSM. In Comparative Example 4, in which annealing temperature was below 200° C., the blistering and peeling in the film occurred although the magnetic property was satisfied. In Comparative Example 5, in which annealing temperature was higher than 350° C., cracks were generated in buffer layer 4 due to the annealing treatment, and vertical magnetic anisotropy also occurred. Thus, soft magnetic performance was unsatisfactory.

As is apparent from the above description, blistering did not occur and good adhesivity between glass substrate 1 and soft magnetic underlayer 5 was achieved in disk substrate 10 for a perpendicular magnetic recording medium in which buffer layer 4 having a thickness in the range of 0.02 to 0.5 μm was formed, buffer layer 4 was annealed at a temperature in the range of 200 to 350° C., and subsequently soft magnetic underlayer 5 was formed. This was clearly different from a disk substrate for a perpendicular magnetic recording medium in which no buffer layer was provided, or the buffer layer thickness or the annealing condition was improper. It has been demonstrated that a perpendicular magnetic recording medium with excellent productivity can be obtained by employing a disk substrate for a perpendicular magnetic recording medium in which this buffer layer is formed and subsequently appropriate annealing is conducted.

A nonmagnetic or magnetic plating film having a thickness of 1 μm or more can be formed with sufficient adhesivity and homogeneity by employing a method of plating on a glass base plate according to the invention, in which after subsequently conducting, on a base plate of a glass material, an alkali degreasing treatment, a glass activation treatment, a silane coupling agent treatment, a palladium catalyst treatment, and a palladium bonding treatment, then, a buffer layer having a thickness in the range of 0.02 μm to 0.5 μm is formed by an electroless plating method, and the buffer layer is annealed at a temperature in the range of 200° C. to 350° C., and subsequently electroless plating is conducted on the buffer layer.

A disk substrate for a perpendicular magnetic recording medium and a perpendicular magnetic recording medium are provided using the disk substrate that comprises a Co—Ni—P soft magnetic underlayer, on a glass substrate as a nonmagnetic substrate, with such a plating thickness, adhesivity, homogeneity, and enough smoothness that are required by a soft magnetic backing layer to provide a perpendicular magnetic recording medium exhibiting satisfactory read/write performance. Such a soft magnetic underlayer of Co—Ni—P electroless plating film can be obtained by using a method of plating according to the invention as described above. That is, after subsequently conducting, on a glass substrate, an alkali degreasing treatment, a glass activation treatment, a silane coupling agent treatment, a palladium catalyst treatment, and a palladium bonding treatment, then a buffer layer having a thickness in the range of 0.02 μm to 0.5 μm is formed by an electroless plating method, and the buffer layer is annealed at a temperature in the range of 200° C. to 350° C. After this, electroless plating of a soft magnetic underlayer of Co—Ni—P is conducted on the buffer layer.

Thus, a perpendicular magnetic recording medium and a method for making it have been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

What is claimed is:

1. A method of plating on a glass base plate, the method comprising a series of treatments sequentially conducted on a surface of a base plate composed of a glass material, the series of treatments including at least
a glass activation treatment,
a silane coupling agent treatment,
a palladium catalyst treatment,
a palladium bonding treatment,
forming a preliminary plating film having a thickness in a range of 0.02 μm to 0.5 μm by means of an electroless plating method, and
annealing at a temperature in a range of 200° C. to 350° C., followed by
electroless plating on the preliminary plating film.

2. A method of manufacturing a disk substrate for a perpendicular magnetic recording medium, the method comprising a series of treatments sequentially conducted on a surface of a glass substrate with a disk shape, the series of treatments including at least
a glass activation treatment,
a silane coupling agent treatment,
a palladium catalyst treatment,
a palladium bonding treatment,
forming a preliminary plating film having a thickness in a range of 0.02 μm to 0.5 μm by means of an electroless plating method, and
annealing at a temperature in a range of 200° C. to 350° C., followed by
forming a soft magnetic plating film on the preliminary plating film by means of an electroless plating method.

3. A disk substrate for a perpendicular magnetic recording medium comprising:
a glass substrate with a disk shape,
an adhesion layer composed of a silane coupling agent formed on the glass substrate,
a catalyst layer composed of a catalyst metal formed on the adhesion layer,
a buffer layer composed of a preliminary plating film having a thickness in a range of 0.02 μm to 0.5 μm that is formed on the catalyst layer by means of an electroless plating method and subjected to an annealing treatment, and
a soft magnetic underlayer composed of a soft magnetic plating film that is formed on the buffer layer by means of an electroless plating method and utilized as at least a part of a soft magnetic backing layer for perpendicular magnetic recording.

4. The disk substrate for a perpendicular magnetic recording medium according to claim 3, wherein the glass substrate is composed of chemically strengthened glass or crystallized glass.

5. The disk substrate for a perpendicular magnetic recording medium according to claim 3, wherein the buffer layer is composed of a soft magnetic alloy or a nonmagnetic alloy.

6. The disk substrate for a perpendicular magnetic recording medium according to claim 4, wherein the buffer layer is composed of a soft magnetic alloy or a nonmagnetic alloy.

7. The disk substrate for a perpendicular magnetic recording medium according to claim 3, wherein the soft magnetic underlayer has a thickness in a range of 0.2 μm to 3 μm.

8. The disk substrate for a perpendicular magnetic recording medium according to claim 5, wherein the soft magnetic underlayer has a thickness in a range of 0.2 μm to 3 μm.

9. The disk substrate for a perpendicular magnetic recording medium according to claim 6, wherein the soft magnetic underlayer has a thickness in a range of 0.2 μm to 3 μm.

10. A perpendicular magnetic recording medium comprising at least a nonmagnetic seed layer, a magnetic recording layer, and a protective layer sequentially formed on the disk substrate for a perpendicular magnetic recording medium according to claim 3, wherein the soft magnetic underlayer of the disk substrate is utilized as at least a part of a soft magnetic backing layer for the magnetic recording layer.

11. A perpendicular magnetic recording medium comprising at least a nonmagnetic seed layer, a magnetic recording layer, and a protective layer sequentially formed on the disk substrate for a perpendicular magnetic recording medium according to claim 4, wherein the soft magnetic underlayer of the disk substrate is utilized as at least a part of a soft magnetic backing layer for the magnetic recording layer.

12. A perpendicular magnetic recording medium comprising at least a nonmagnetic seed layer, a magnetic recording layer, and a protective layer sequentially formed on the disk substrate for a perpendicular magnetic recording medium according to claim 6, wherein the soft magnetic underlayer of the disk substrate is utilized as at least a part of a soft magnetic backing layer for the magnetic recording layer.

13. A perpendicular magnetic recording medium comprising at least a nonmagnetic seed layer, a magnetic recording layer, and a protective layer sequentially formed on the disk substrate for a perpendicular magnetic recording medium according to claim 7, wherein the soft magnetic underlayer of the disk substrate is utilized as at least a part of a soft magnetic backing layer for the magnetic recording layer.
